(19) United States
(12) Patent Application Publication
(10) Pub. No.: US 2026/0034757 A1
(43) Pub. Date: Feb. 5, 2026

(54) A ROTARY TABLET PRESS COMPRISING A FILLING DEVICE AND A SUPPORT ASSEMBLY

(71) Applicant: GEA Process Engineering nv, Halle (BE)

(72) Inventors: Nicolas Robin, Halle (BE); James William Holman, Halle (BE); Antonie Van Zegbroeck, Halle (BE); Frederik Detobel, Halle (BE)

(73) Assignee: GEA Process Engineering nv, Halle (BE)

(21) Appl. No.: 19/099,905

(22) PCT Filed: Aug. 21, 2023
(86) PCT No.: PCT/EP2023/072942

§ 371 Date: Jan. 30, 2025

(30) Foreign Application Priority Data
Aug. 19, 2022 (EP) 22191304.9

(51) Int. Cl. B30B 15/30; B30B 11/08

(52) U.S. Cl. CPC B30B 15/302; B30B 11/08

(57) ABSTRACT

A rotary tablet press comprising a filling device and a support assembly The rotary tablet press (1) comprises a housing (2), a turret (10) positioned in the compression section in an operational position, at least one filling device (12) associated with the turret (10). A support assembly (160) is provided to support a feeder (15) of a filling device (12) of the rotary tablet press (1), the support assembly being configured such that the view to the second portion and across the gap is substantially unimpeded.

### TECHNICAL FIELD

The present invention relates to a rotary tablet press comprising a turret, the turret comprising a die disc, a top punch guide, a bottom punch guide, and a plurality of punches, wherein the rotary tablet press comprises at least one filling device with a feeder positioned between the die disc and the top punch guide.

### BACKGROUND ART

In such a rotary tablet press, the at least one filling device typically delivers an input material, which the turret of the tablet press is to process. The input material may be in the form of a powder or a granulate. Often, the at least one filling device must typically be located at a specific, predetermined location relative to the die disc for the filling device to be able to deliver the input material to the die disc. The at least one filling device can be arranged at the predetermined location by an operator's visual inspection of a distance between the die disc and a side of the at least one filling device or by measuring the distance.

Due to various operating conditions of the rotary tablet press, for instance such as temperatures of the parts of the rotary tablet press and turret and/or wear of certain parts, the die disc and the at least one filling device may traditionally move relative to each other. Thereby the at least one filling device may be moved away from the specific, predetermined location relative to the die disc. This, in turn, leads to a material loss.

An existing solution to this problem, is to provide the feeder on a support structure from below when seen in the vertical direction, i.e. an axial direction of a turret, in an operational condition of the rotary tablet press. The support structure can then be moved in the vertical direction to adjust a vertical position of the feeder relative to the die disc.

However, such known and existing solutions are typically large and bulky, taking up space around the feeder. This, again makes an adjustment of the position of the filling device relative to the die disc difficult and cumbersome due to poor accessibility and/or visibility.

Document US 2004/207107A1 discloses an example of a rotary tablet press, in which the feeder is supported by a relatively complex support structure, which furthermore takes up space below the feeder.

It is therefore desired to provide a rotary tablet press allowing for an easy and improved adjustment of the position of the filling device relative to the die disc.

It is furthermore a general desire to improve cleanability and facilitate an easy cleaning of parts of a rotary tablet press.

### SUMMARY OF THE INVENTION

An object of the present invention is to provide a rotary tablet press overcoming at least some of the above-mentioned drawbacks.

This and further objects are achieved by a rotary tablet press according to the invention comprising
a turret comprising a die disc, a top punch guide, a bottom punch guide, and a plurality of punches, and
at least one filling device associated with the turret, said filling device comprising a feeder positioned between the die disc and the top punch guide and comprising a bottom side facing a top side of the die disc,
wherein the turret defines an axial direction, a radial direction, and a tangential direction,
wherein the rotary tablet press comprises a support assembly for providing support to the filling device,
and which is furthermore characterised in that
the bottom side of the feeder comprises a first portion and a second portion, wherein the first portion overlaps the top side of the die disc, that the support assembly comprises at least one pillar configured to set a predefined gap in the axial direction between the bottom side of the feeder and the top side of the die disc in the overlapping first portion, and that the at least one pillar is configured such that the view to the second portion and across the gap is substantially unimpeded.

By providing a support assembly comprising at least one pillar configured to set the predefined gap between the first portion and the die disc, an easy adjustment of this distance may be provided. Furthermore, as the view across the gap is substantially unimpeded, a visual inspection or an instrumental inspection of the gap by means of a ruler or gauge may be provided, thereby further allowing for an easy and accurate adjustment. Notably, where adjustment means to adjust the gap by means of the pillar are arranged outside a turret enclosure, where a such is provided, the adjustment may be performed without removing the enclosure.

By the at least one pillar being configured to provide an unimpeded view to the second portion, the second portion may comprise a removable cover, which can provide access to the interior of the feeder so as to provide an improved cleaning of the feeder. Furthermore, by providing an unimpeded view to the second portion, an instrumental inspection of the gap may furthermore be provided, as this leaves more available space for the user to hold and/or navigate the instrument.

By the view to the second portion and across the gap being substantially unimpeded may herein be understood that a user may be able to view the substantially entire or a major portion of the second portion, such as a surface of the second portion. By the view across the gap being substantially unimpeded may herein be understood that a user may be able to view substantially the entire gap or a major portion of the gap, for instance when looking at the gap in a radial direction within at least selected angle ranges. The term “unimpeded” is to be understood in the ordinary sense of the word, namely that the view to the second portion and across the gap is substantially free from obstacles and hindrances that could otherwise block a line of vision of a user.

By the first portion overlapping the top side of the die disc may herein be understood that the first portion overlaps the top side of the die disc when seen along the axial direction. Alternatively or additionally, the first portion may overlap the top side of the die disc in the radial direction and/or in the tangential direction, e.g. so that the one or more points of the first portion and one or more points of the die disc may have a same radial coordinate. The first portion may overlap a part or some of the die disc top side. The gap may extend and/or have a predefined height in the axial direction.

It will be appreciated throughout this description that pillars may refer to any supporting structure, which is suitable for and/or configured to support the feeder. Notably, the terms “pillar” and “supporting structure” may be used interchangeably throughout this text. Such pillars or supporting structures may be elongate or substantially column-shaped or column-shaped or may have different shapes, such as substantially cylinder-shaped, cylinder-shaped, substantially cuboid-shaped, cuboid-shaped, substantially pyramid-shaped, pyramid-shaped, substantially cone-shaped, cone-shaped, or any combination thereof. The pillars or supporting structures may be configured to provide support in any direction, such as a vertical direction, in a horizontal direction, or in a direction with an angle with respect to the vertical and/or horizontal direction.

It will furthermore be appreciated that where the term “radial direction” is used throughout this application, this may refer to any radial direction. In particular, any direction having a directional vector parallel to a radial unity vector may be denoted a radial direction throughout this text. A radial direction may alternatively or additionally be any direction having a directional vector which is normal to the axial direction or any direction in a plane, on which a directional vector of the axial direction is normal and/or to which the axial direction is orthogonal.

A radial direction may alternatively or additionally be any direction in a substantially horizontal or horizontal plane.

In some embodiments, the second portion comprises a bottom surface, and the at least one pillar may be configured such that the view to the bottom surface of the second portion is substantially unimpeded. The bottom surface of the second portion may be substantially parallel to a surface of the first portion and/or to a top surface of the top side of the die disc. Alternatively or additionally, the bottom surface of the second portion may extend in a plane substantially orthogonal to the axial direction, and/or to which plane a unity vector in the axial direction is a normal vector.

The at least one pillar may be in physical contact with, such as engaged with, physically connected to, and/or formed in one piece with, a part of the second portion or a part of the bottom surface of the feeder bottom side or a part of the top or side of the feeder. The part of the second portion or bottom surface may be less than 25%, preferably less than 20%, preferably less than 15%, preferably less than 10%, such as less than 5% of the second portion or bottom surface, respectively.

The axial direction may be a substantially vertical direction in an operational condition of the rotary tablet press. The unobstructed view to the second portion may be a view unobstructed from a lower side in the vertical direction. Alternatively or additionally, an unobstructed view to the gap may be in the radial direction and/or in a substantially horizontal direction, perpendicular to the axial direction.

Throughout this disclosure, it will be appreciated that any feature described with respect to the bottom side of the feeder may equally apply to an upper side of the feeder.

By the at least one pillar configured to set a predefined gap in the axial direction between the bottom side of the feeder and the top side of the die disc in the overlapping first portion, it may be understood that the pillar may be configured to allow an adjustment of the gap in the axial direction between the bottom side of the feeder and the top side of the die disc in the overlapping 25 portion. Specifically, the at least one pillar may be configured to physically move the feeder, potentially by moving the feeding device.

The support assembly may comprise any number of adjustment means operably connected to the at least one pillar so as to set the predefined gap.

The rotary tables press may comprise at least one turret, such as one or a plurality of turrets.

In some embodiments, the at least one pillar is configured to be arranged so that an air gap in the axial direction between a surface of the second portion and another part of the rotary tablet press, such as a bottom surface of the rotary tablet press or a bottom wall of an enclosure, extends over at least 50% of the surface of the second portion, such as over at least 60%, at least 70%, at least 80%, at least 85%, at least 90%, or at least 95% of the surface of the second portion.

The surface of the second portion may be the surface of the second portion, which faces the other part of the rotary tablet press. Alternatively, the surface may be the entire surface of the second portion.

Alternatively or additionally, the pillar(s) may be arranged so that an air gap is present between at least 60%, at least 70%, at least 80%, at least 85%, at least 90%, or at least 95% of the surface of the second portion, potentially when seen in the axial direction.

In some embodiments, the feeder is supported by the one or more pillars in the axial direction and/or in the radial direction.

In some embodiments, at least one of said at least one pillar extends between a bottom surface of the rotary tablet press the bottom side of the feeder, preferably one, two, or three pillars.

Thereby a stable support of the feeder may be provided by means of the at least one pillar.

The at least one of said at least one pillar may be connected, such as rigidly or adjustably connected, to the bottom surface and connected, such as rigidly or adjustably, to the bottom side of the feeder. Alternatively or additionally, the at least one of said at least one pillar is rigidly fixed to and/or mounted on the bottom surface.

An adjustable connection may comprise one or more of a roller, a bearing, or the like allowing for a movement in one or more of the axial, radial, and tangential direction.

The at least one of said at least one pillar may comprise an adjustment means for allowing adjustment of a part of the at least one of said at least one pillar in at least the axial direction so as to adjust a position of the feeder. The adjustment means may be provided by means of a thread, for instance provided in the pillars, in a part rigidly connected to the pillars, and/or in a nut, comprising one or more turns and a corresponding threaded connector, such as a screw, bolt, or the like. In this example, the position of the feeder may be adjusted in a respective direction by turning the threaded connector. Alternatively or additionally, the at least one of said at least one pillar may comprise a locking means configured to lock a position of feeder.

In some embodiments, at least one of said at least one pillar extends between a bottom surface of the rotary tablet press and the second portion of the bottom side of the feeder, preferably one, two, or three pillars.

Alternatively or additionally, at least one of said at least one pillar may extend between a bottom surface of the rotary tablet press and the first portion of the bottom side of the feeder, preferably one, two, or three pillars. The at least one of said at least one pillar may be substantially L-shaped.

In some embodiments, at least one of said at least one pillar extends between a top surface of the rotary tablet press or an enclosure thereof and a top side of the feeder.

Thereby, a stable support of the feeder may be provided by means of the at least one pillar. By the at least one of said at least one pillar extending between a top surface of the rotary tablet press or an enclosure thereof and a top side of the feeder, a support of the feeder may be aided by the at least one of said at least one pillar without interfacing with bottom side, thereby reducing the number of pillars or structures potentially obstructing a view to the second portion of the bottom side.

The top surface may be a surface positioned above the die disc, such as above the top punch guide. The top surface may be positioned above the die disc and/or top punch guide in a vertical direction in an operational condition of the rotary tablet press.

The top side of the feeder may be a side opposite the bottom side of the feeder. The top side of the feeder may, in an operational condition of the rotary tables press, be arranged above the bottom side in the vertical direction.

The at least one of said at least one pillar may be connected, such as rigidly or adjustably connected, to the top surface and connected, such as rigidly or adjustably, to the top side of the feeder. Alternatively or additionally, the at least one of said at least one pillar is rigidly fixed to and/or mounted on the top surface.

In some embodiments, the feeder is suspended by the at least one pillar, preferably exclusively suspended by the at least one pillar, to allow adjustment of the bottom side of the feeder relative to the top side of the die disc.

Thereby, the number of components at or around the second portion of the bottom side may be reduced, potentially so that no components of the support assembly are arranged at or around the second portion of the bottom side. Furthermore, any adjustment means for adjusting a position of the feeder in the axial direction may be arranged at the top side and/or above the feeder, thereby allowing for an easy adjustment of the position of the feeder.

By the feeder being suspended may herein be understood that the feeder is suspended and/or hung from above in a vertical direction in an operational condition of the rotary tablet press.

Any adjustment means may comprise one or more of a thread and a threaded device, such as a screw, a bolt, or the like. The adjustment means may be arranged so that an adjustment by means of the adjustment means may be configured to physically move the feeder.

In some embodiments, at least one of said at least one pillar extends between a side surface of the rotary tablet press or an enclosure thereof and the feeder.

Thereby, a further support may be provided to the feeder.

The side surface may be arranged in between and/or extending between the bottom surface and a top surface of the rotary tablet press. The side surface may be substantially orthogonal to at least part of the top surface and/or at least part of the bottom surface. In some embodiments, the side surface may be a first side surface, which, in an operational condition of the rotary tablet press, faces away from a rotational axis of the die disc, of the bottom punch guide, and/or of the top punch guide.

The at least one of said at least one pillar may be connected, such as rigidly or adjustably connected, to the side surface and connected, such as rigidly or adjustably, to the top side of the feeder. Alternatively or additionally, the at least one of said at least one pillar is rigidly fixed to and/or mounted on the top surface.

The at least one of said at least one pillar may be configured to allow an adjustment of the feeder in a radial and/or tangential direction.

In some embodiments, the rotary tablet press comprises an enclosure surrounding the turret in its operational position in the compression section of the rotary tablet press.

The enclosure may enclose a volume, in which the bottom punch guide, the die disc, and the top punch guide is arranged.

The enclosure may provide a contained volume within the enclosure.

By the term “contained volume” is herein to be understood that the volume is to fulfil certain requirements to containment, i.e. that the volume, of the enclosure, is at least dust tight. Correspondingly, a contained volume may be a volume, which is configured to prevent that extensive amounts, such as detectable amounts and/or amounts over a certain threshold, of an input composition, which the turret of the rotary tablet press is processing, are emitted from the contained volume into the surroundings, such as into a room in which it is arranged or into an enclosure surrounding at least a part of the turret. By “contained volume” may herein be understood that the volume is to have a containment capability of dust containment of up to 10 μg per m³. Correspondingly the contained volume may be a volume, which when in the installed is configured to have a dust containment of up to 10 μg per m³.

In some embodiments, the enclosure is suspended from a suspension device positioned above the top punch guide.

The suspension device may be provided to suspend the enclosure so that a rotation of the die disc, bottom punch guide, and top punch guide does not cause a rotation of the top punch guide.

In some embodiments, said at least one pillar is suspended from the enclosure.

Thereby, the enclosure and the at least one pillar may have a same reference point, i.e. by means of the suspension device, relative to the rotational die disc, bottom punch guide, and top punch guide, allowing for a more accurate adjustment. Furthermore, this may allow for an adjustment to be performed during operation of the rotary tablet press and/or without breaking a containment, for instance where the enclosure provides a contained volume within the enclosure.

In some embodiments, an adjustment of the enclosure may lead to an adjustment of the feeder by means of the at least one pillar.

At least one of said at least one pillar may be configured to extend between a top surface, such as an internal side of the top surface, of the enclosure and the top surface of the feeder. A potential adjustment means to adjust the at least one of said at least one pillar may be provided on an external side of the enclosure. An internal side may be a side facing the volume enclosed by the enclosure. An external side may be a side facing towards the exterior of the enclosure.

In some embodiments, the bottom surface and the side surface are provided on the enclosure.

In some embodiments, the bottom side of the feeder is substantially plane.

In some embodiments, the second portion of the bottom side is free-hanging such that the view to the second portion and across the gap is unimpeded.

The second portion may be free-hanging by means of at least one pillar extending exclusively between the top side of the feeder and a top surface of the rotary tablet press, such as a top surface of an enclosure thereof, and/or between the side surface of the feeder and a side surface of the rotary tablet press, such as a side surface of an enclosure thereof.

In some embodiments, said at least one pillar extends from a bottom surface of the rotary tablet press or an enclosure thereof to the feeder, and wherein the geometrical extension of said at least one pillar, as projected on the second part of the bottom surface, and as projected on a vertical plane parallel to the axial direction, is below 10%, preferably below 5%, of the second portion of the bottom surface and on the projected area, respectively.

Thereby, any pillar extending between the bottom side, such as the second portion thereof, and a bottom surface may be arranged so that it does not obstruct the view the second portion and, preferably, to the gap.

A maximum cross-section in a plane perpendicular to the axial direction, i.e. in a plane to which a unity vector extending in the axial direction is a normal vector, of the at least one pillar may be below 20%, preferably below 15%, preferably below 10%, preferably below 5%, of a surface area of a surface of the second portion.

In some embodiments, at least one part of the second portion is openable, preferably by means of a hinge connection.

Thereby, an improved cleaning may be provided, as the internal of the feeder may be accessible by opening the second portion. For instance, this allows for applying suction, such as a vacuum cleaner, to the feeder via the openable second portion. Alternatively or additionally, this allows for applying a cleaning fluid or liquid, such as spraying in water, into the internal of the feeder and drain the cleaning fluid or liquid by means of the openable second portion.

The at least one openable part of the second portion may be the substantially entire second portion and/or more than 30%, such as more than 40%, more than 50%, more than 60%, more than 70%, such as more than 80% of the second portion or of a surface of the second portion. Alternatively, the openable part of the second portion may be a draining portion of the second portion, potentially being less than 30% of the second portion.

The second portion may be openable from below when seen in the vertical direction.

The part of the second portion may be openable by means of one or more hinges, potentially being arranged at least partially on a non-openable part of the second portion. Alternatively, the second portion may be openable by means of one or more of magnets, screws, bolts, or the like.

In some embodiments, said at least one pillar comprises a clamping device for locking the filling device at a predefined position.

Thereby, the predefined position of the filling device or the feeder may be maintained, e.g. during operation.

Where an enclosure is provided, the clamping device may be arranged on an external side of the enclosure.

In some embodiments, the at least one pillar of the support assembly comprises one or more adjustment devices configured to allow an adjustment of the position of the filling device in the axial direction, the radial direction, and the tangential direction.

Thereby, six degrees of freedom of movement of the feeder may be provided, in turn allowing for a further improved accuracy of the positioning of the feeder at the predetermined location.

The one or more adjustment devices may be arranged on a respective one of the at least one pillar, potentially so that each of the at least one pillar comprises a respective adjustment device.

The adjustment devices may be provided by means of threads and bolts or screws or the like of each of the at least one pillar.

Presently preferred embodiments and further advantages will be apparent from the subsequent detailed description and drawings. A person skilled in the art will appreciate that any one or more of the above aspects of this disclosure and embodiments thereof may be combined with any one or more of the other aspects of the disclosure and embodiments.

### BRIEF DESCRIPTION OF DRAWINGS

In the following description embodiments of the invention will be described with reference to the drawings, in which

FIG. 1 is a perspective view of a rotary tablet press in a first embodiment of the invention, as seen from a front side of the rotary tablet press;

FIG. 2 is a view of the embodiment of FIG. 1, with an openable part of the feeder bottom side shown in an open position;

FIG. 3 is a perspective view of a rotary tablet press in a second embodiment of the invention, as seen from a front side of the rotary tablet press;

FIG. 4 is a view of the embodiment of FIG. 3, with an openable part of the feeder bottom side shown in an open position;

FIG. 5 is a perspective view of details of a rotary tablet press in a third embodiment of the invention;

FIG. 6 is a view of the embodiment of FIG. 5, shown from a different angle;

FIG. 7 is a front view of the embodiment of FIG. 5;

FIG. 8 is cross-sectional view of details of a rotary tablet press in a fourth embodiment of the invention;

FIG. 9 is a perspective view of details of a rotary tablet press in a fifth embodiment of the invention;

FIG. 10 is a view of the details of FIG. 9, shown from a different angle;

FIG. 11 is a view of the embodiment of FIG. 9, with an openable part of the feeder bottom side shown in an open position;

FIG. 12 is a front view of the embodiment of FIG. 9;

FIG. 13 is a view corresponding to FIG. 11 of a sixth embodiment of the invention;

FIG. 14 is a perspective view of details of a rotary tablet press in a seventh embodiment of the invention;

FIG. 15 a perspective view of details of a rotary tablet press in a eighth embodiment of the invention; and

FIG. 16 is a view corresponding to FIG. 15 of the eighth embodiment of the invention.

### DETAILED DESCRIPTION

The present invention will now be described in more detail hereinafter with reference to the accompanying drawings, in which an embodiment of the invention is shown. This invention may, however, be embodied in many different forms and should not be construed as limited to the embodiments set forth herein; rather, these embodiments are provided for thoroughness and completeness.

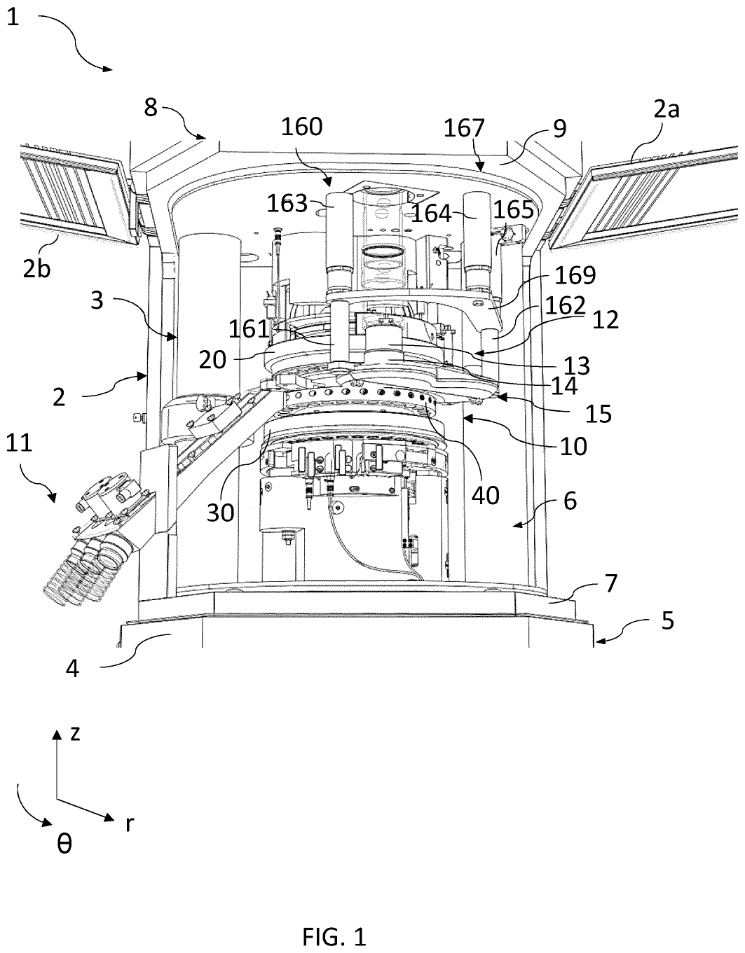

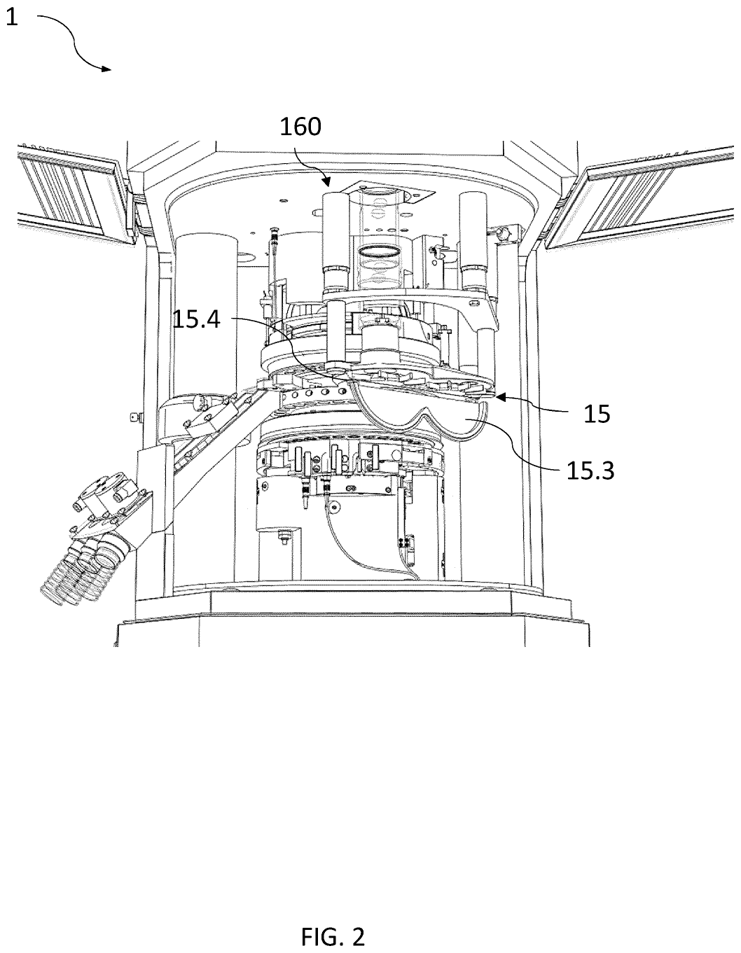

FIGS. 1 and 2 show a rotary tablet press generally designated 1 in a first embodiment of the invention, as seen from a front side of the rotary tablet press 1. The rotary tablet press 1 has a housing 2 comprising a frame 3 and an outer lining 4. The housing 2 is composed of three sections, which are located on top of each other and are separated by means of partition walls. The lower section, designated the drive section 5, is separated from a central section, designated the compression section 6, by a bottom frame 7 of the rotary tablet press 1, and the compression section 6 is separated from an upper section, designated the accessory section 8, by a top frame 9 of the rotary tablet press 1. Wall elements 2a, 2b are openable as indicated by the position shown; during operation, the wall elements 2a, 2b close off the compression section 6. Further parts may be present but not shown, including caps to prevent excessive contamination of mechanical parts within the compression section 6.

In a manner known per se the housing 2 accommodates a turret 10. During operation of the tablet press, the turret 10 is positioned in an operational position in the compression section 6 of the housing 2, but may be removed from the compression section 6 in order to allow cleaning, change-over of parts etc. The turret 10 comprises a plurality of rotating parts of which only a die disc 40 is indicated. The die disc 40 is substantially plate-shaped with a die disc surface and has a number of bores, typically accommodating a corresponding number of dies adapted for forming the tablets to the desired shape and size. Further parts include top and bottom punch guides with guide bores in which top and bottom punches are accommodated reciprocally so that a first end of each punch is able to enter a corresponding die, or the bore itself, if no die is present, by displacement of the associated punch in its guide bore, in order to compress material in the die or bore.

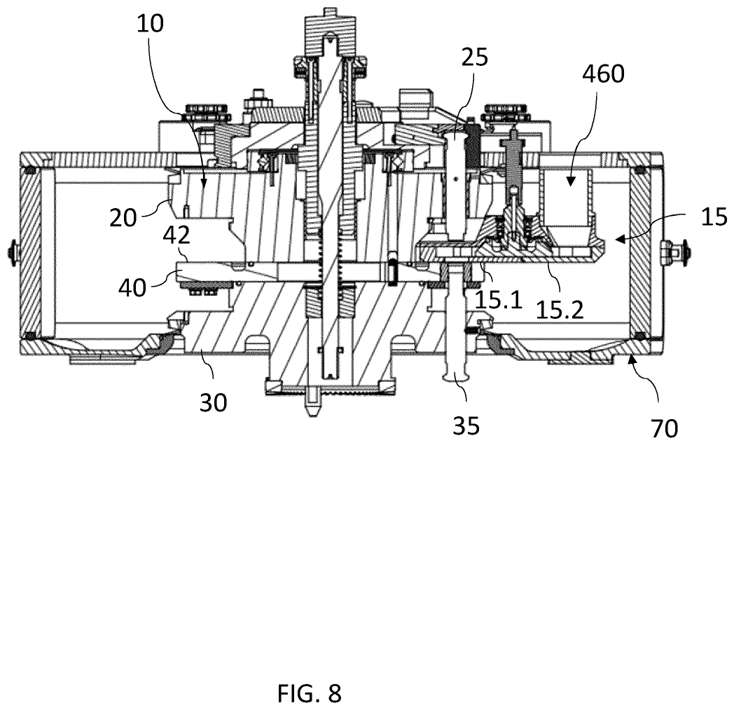

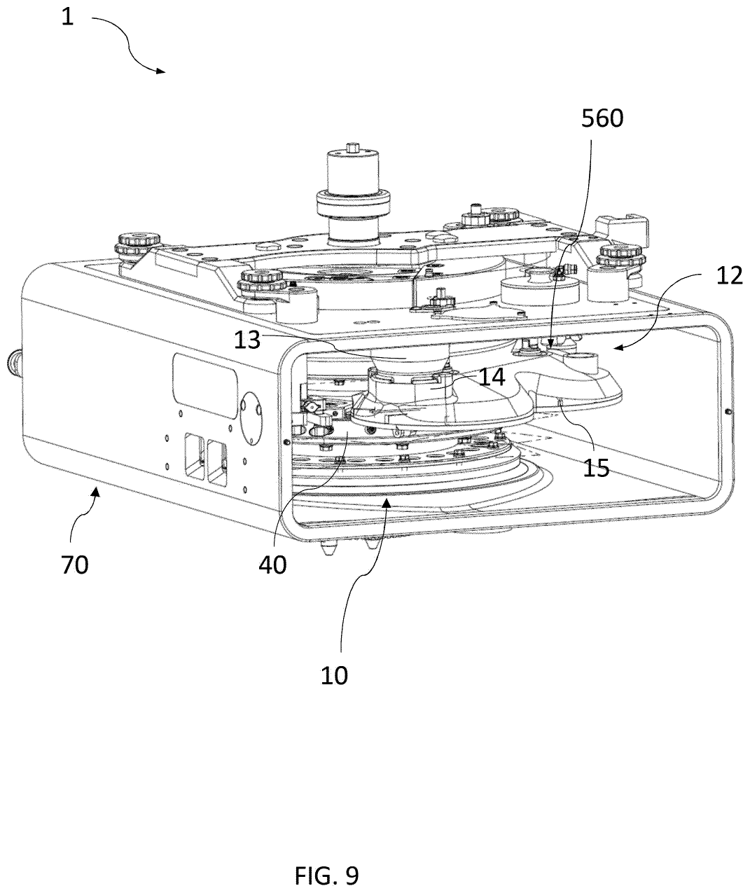

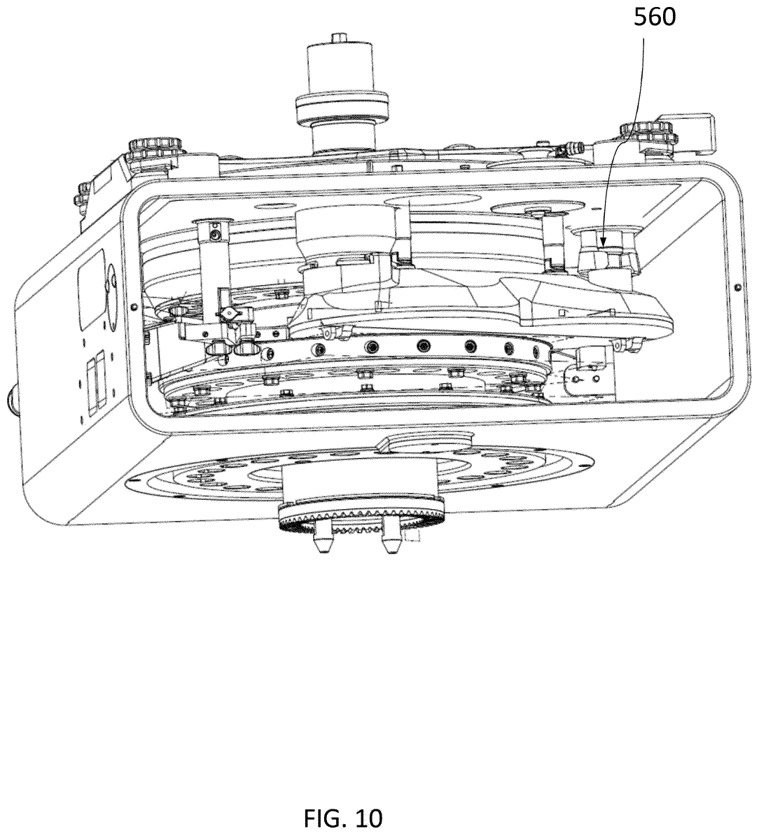

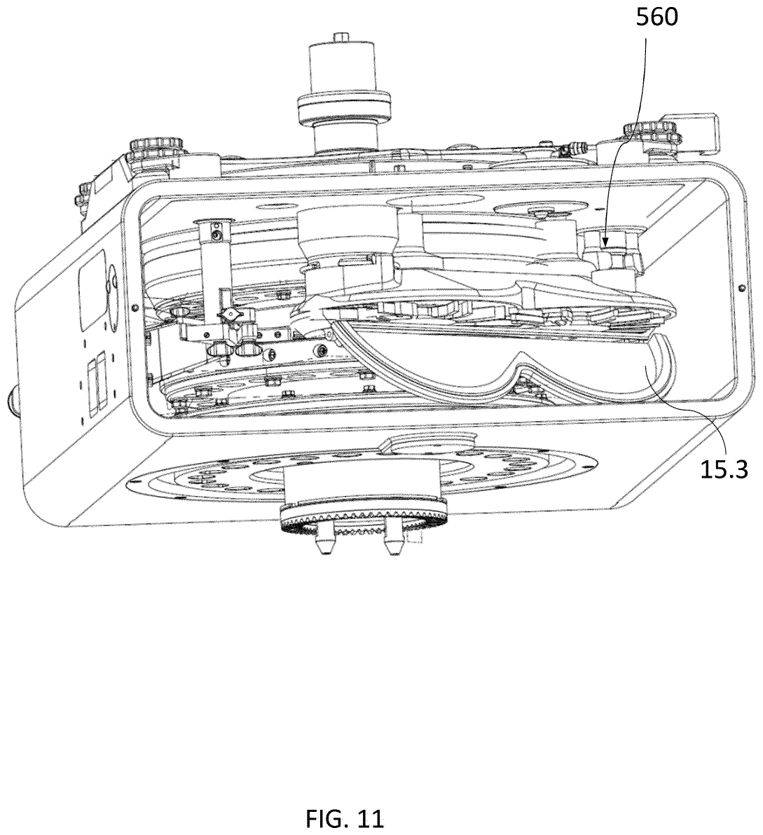

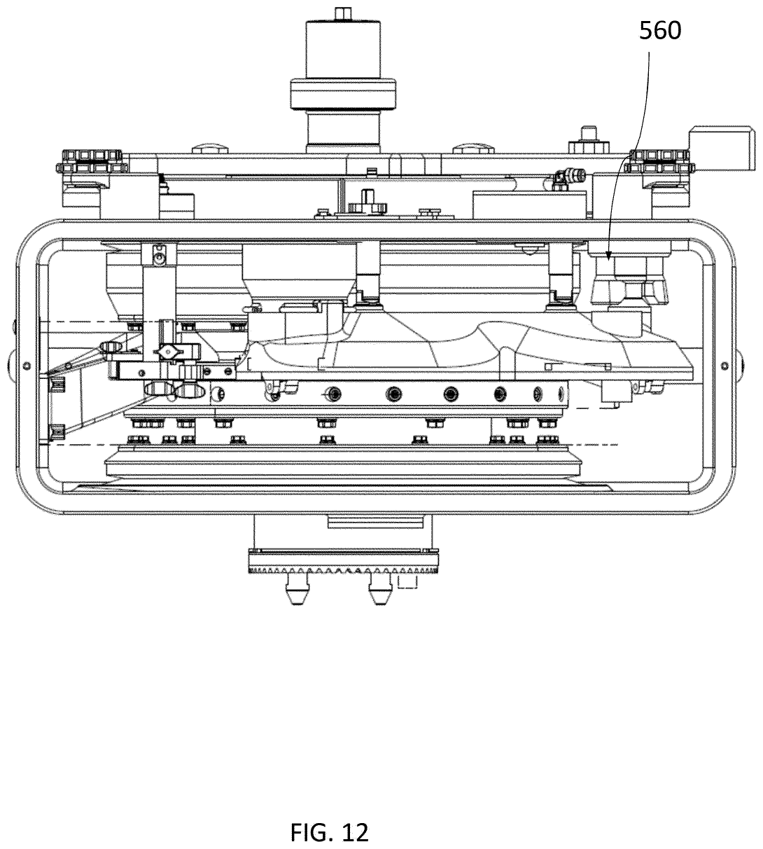

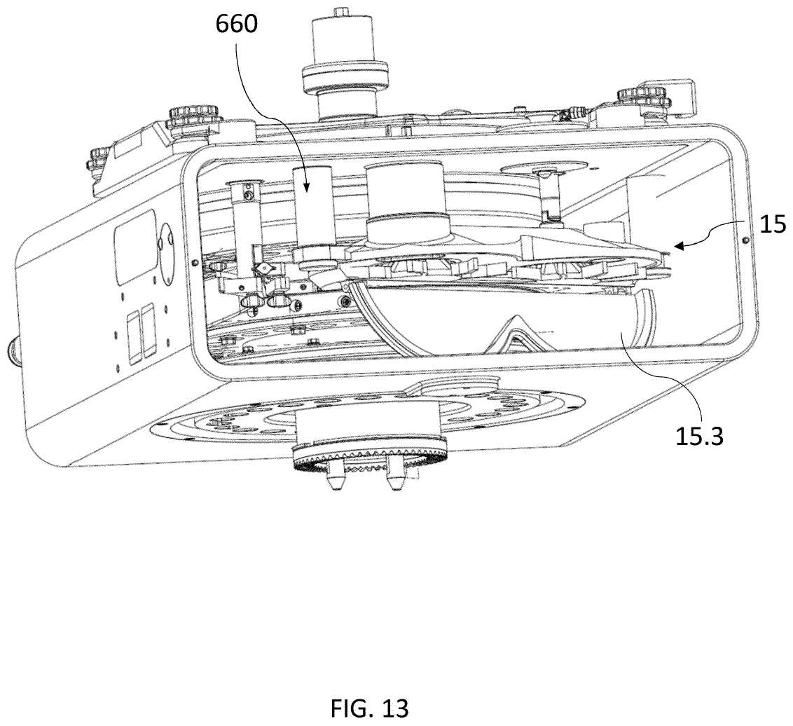

A filling device 12 is associated with the turret 10. More than one filling device 12 may be provided. The filling device 12 comprises a feeder 15 positioned between the die disc 40 and the top punch guide 20. The feeder 15 is connected to a powder inlet tube 13 and a powder distribution device also denoted a fill show 14. The feeder 15 comprises a bottom side facing a top side 42 of the die disc 40, cf. FIG. 8.

The turret 10 defines an axial direction z, a radial direction r, and a tangential direction θ.

Further details indicated in FIG. 1 include a tablet chute 11 protruding from the turret 10 at an angle for conducting away compressed material in the form of tablets from the die bores. The tablet chute 11 is one of a number of auxiliary components associated with the turret 10.

Further details not shown may include a scraper adapted to scrape off excess powder, thereby ensuring that only the desired amount of powder is present in the die disc, an ejection finger, a recuperation finger and further cams. Other elements may be present in the rotary tablet press 1 and means for controlling the tablet press according to desired settings may be provided as well.

The rotary tablet press comprises a support assembly 160 for providing support to the filling device 12.

Referring again briefly to FIG. 8 for an indication of the relevant details of the feeder 15 and the die disc 40, the bottom side of the feeder 15 comprises a first portion 15.1 and a second portion 15.2, defined such that the first portion 15.1 is the portion that overlaps the top side 42 of the die disc 40.

As will be described in further detail below for each of the six shown embodiments of the rotary tablet press 1, the support assembly comprises at least one pillar configured to set a predefined gap in the axial direction z between the bottom side of the feeder 15 and the top side 42 of the die disc 40 in the overlapping first portion 15.1. The at least one pillar is configured such that the view to the second portion 15.2 and across the gap is substantially unimpeded.

Throughout the embodiments, the feeder 15 and the die disc 40 are shown as having a consistent configuration; variations are however conceivable.

In the first embodiment, the support assembly 160 comprises five pillars 161, 162, 163, 164, 165 to extend between a top surface of the rotary tablet press and a top side of the feeder. This is carried out in that two pillars 161, 162 which form a lower set of pillars are connected to the top side of the feeder 15 at one end and to a plate 169 at an opposite end. Correspondingly, three pillars 163, 164, and 165 which form a set of upper pillars are connected to the plate 169 at one end and to the top surface of the rotary tablet press 1, as shown to the top frame 9.

As indicated schematically, adjustment means 167 are provided on the upper set of pillars to adjust the position of the feeder. Throughout the embodiments, at least one pillar of the support assembly may comprise one or more adjustment devices configured to allow an adjustment of the position of the filling device 12 in the axial direction z, a radial direction r, and a tangential direction θ

The feeder 15 is thus suspended by the pillars in the first embodiment. While it is conceivable that support may also be provided from below, here the feeder 15 is exclusively suspended by the at least one pillar to allow adjustment of the bottom side of the feeder 15 relative to the top side of the die disc.

A feature of the first embodiment is shown in FIG. 2, namely that a part 15.3 of the second portion 15.2 is openable, in the embodiment shown by means of a hinge connection 15.4.

The bottom side of the feeder is substantially plane, i.e. all areas of the first portion 15.1 and the second portion 15.2 are located in a continuous plane.

Due to the configuration of the support assembly 160 of the first embodiment, the second portion 15.2 of the bottom side of the feeder 15 is free-hanging such that the view to the second portion 15.2 and across the gap formed between the overlapping first portion 15.1 and the top surface 42 of the die disc 40 is unimpeded.

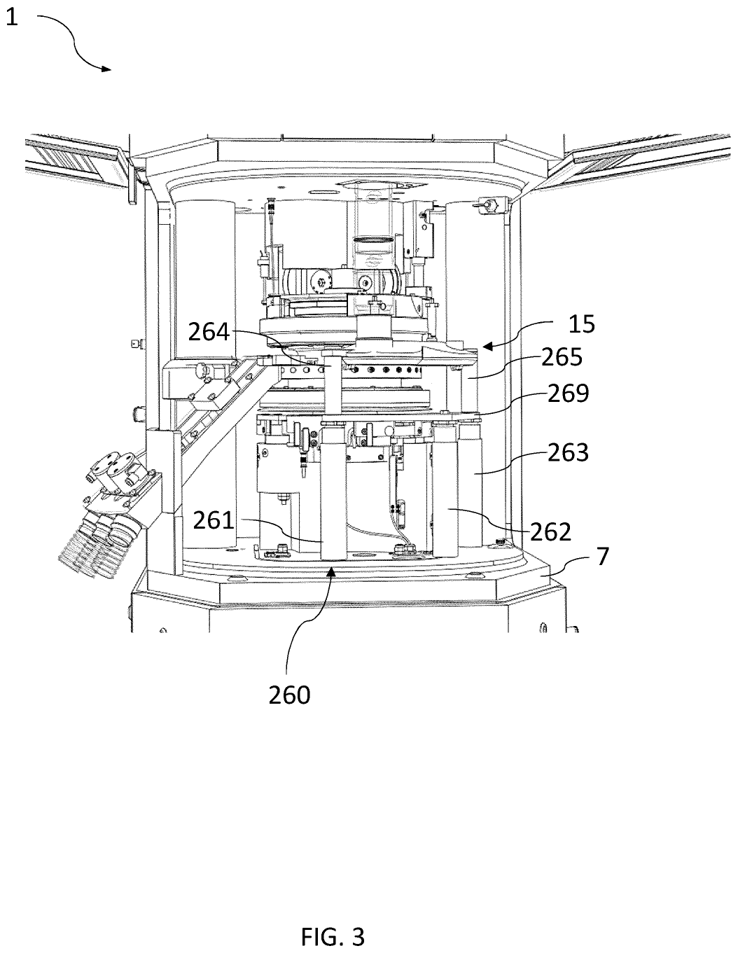

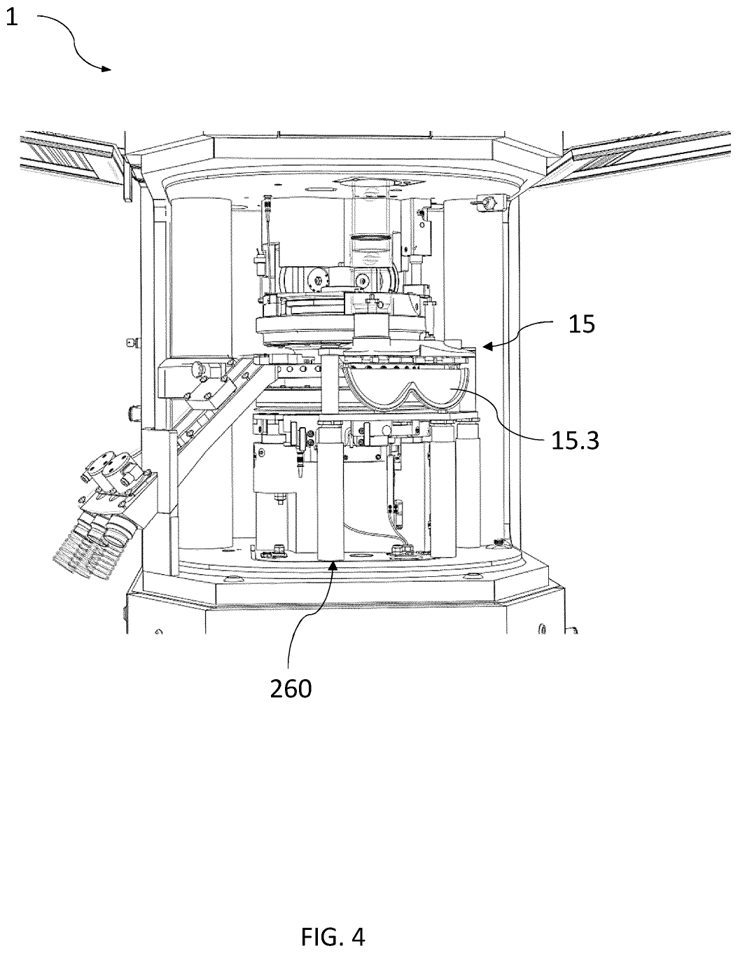

Referring now to FIGS. 3 and 4, a second embodiment will be described. Elements having the same or an analogous function as in the first embodiment are denoted by the same reference numerals to which 100 has been added. Only differences will be described in detail.

In the second embodiment, pillars 261, 262, 263, 264, 265 extend between a bottom surface of the rotary tablet press, here the bottom frame 7, and the second portion 15.2 of the bottom side of the feeder 15. It is also conceivable to let pillars extending from a bottom surface of the rotary tablet press and to a top or side of the feeder. As in the first embodiment, the pillars are divided into an upper set and a lower set.

As the pillars of the support assembly 260 of the second embodiment extend from a bottom surface of the rotary tablet press, here the bottom frame 7, to the feeder 15, the pillars necessarily covers the view to the second portion 15.2 and the gap between the first portion 15.1 and the top surface 42 of the die disc 40 slightly. It is preferred that the obstruction is minimized and it is preferred that the geometrical extension of said at least one pillar, as projected on the second part of the bottom surface, and as projected on a vertical plane parallel to the axial direction z, is below 10%, preferably below 5%, of the second portion of the bottom surface and on the projected area, respectively.

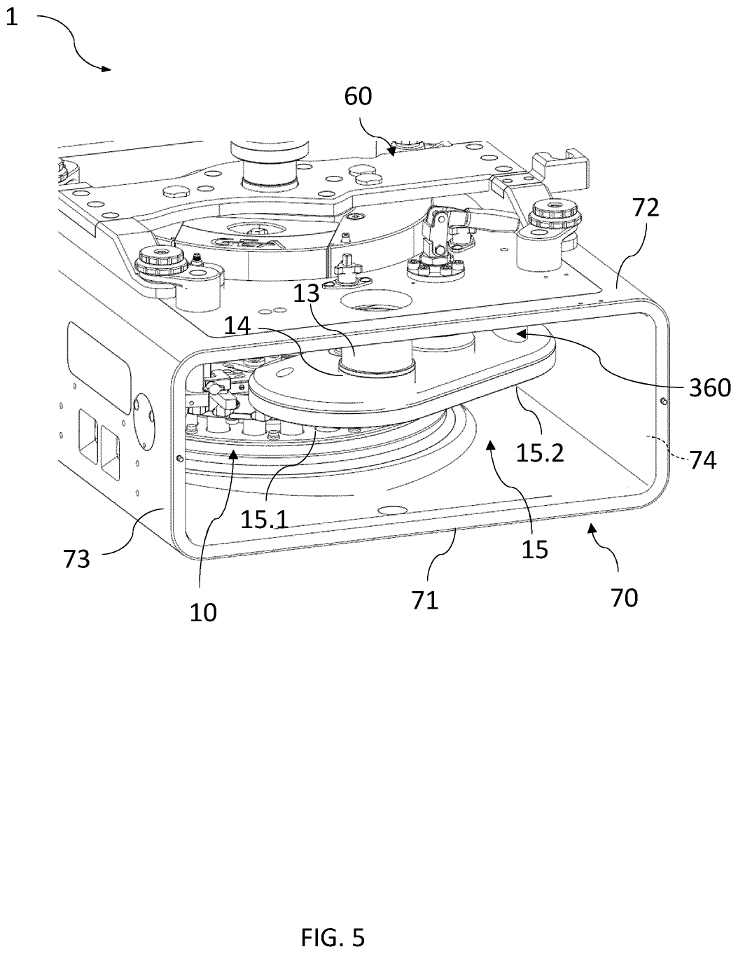

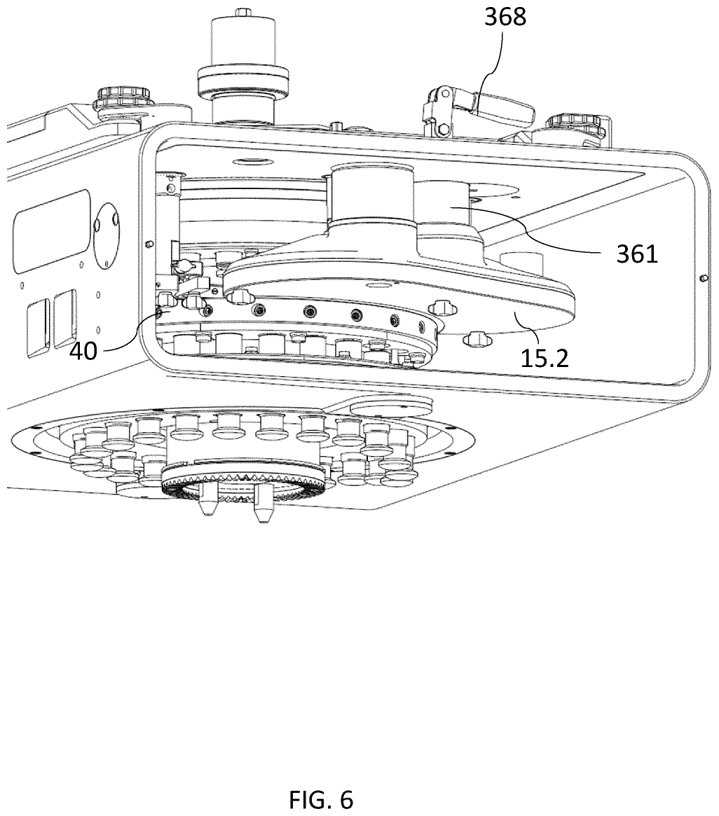

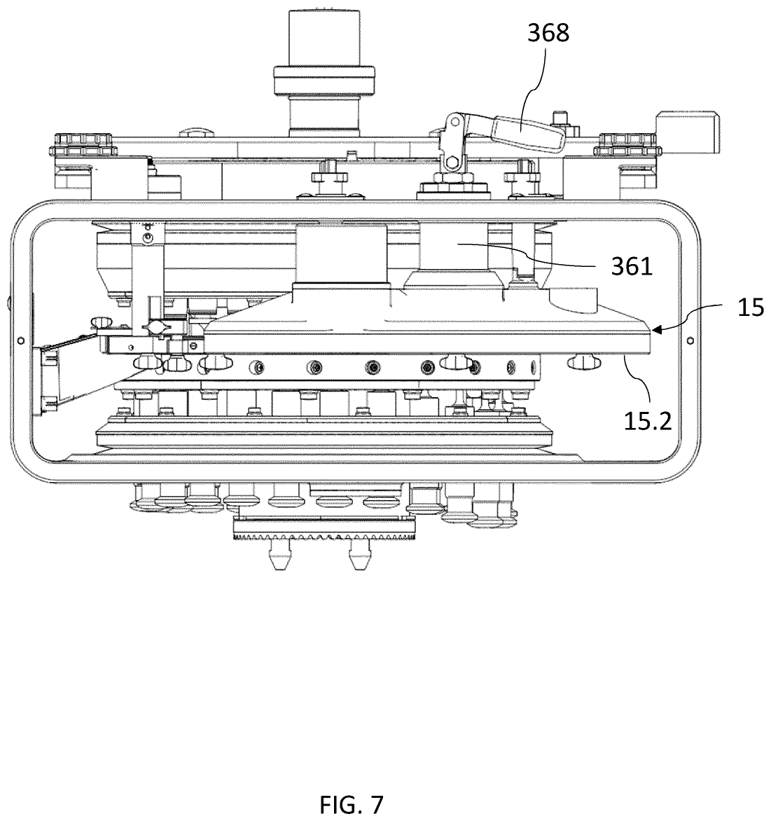

Turning now to FIGS. 5 to 7, a third embodiment is shown. Elements having the same or an analogous function as in the first embodiment are denoted by the same reference numerals to which 200 has been added. Only differences will be described in detail.

The rotary tablet press 1 comprises an enclosure 70 surrounding the turret 10 in its operational position in the compression section 6 of the rotary tablet press. The enclosure 70 comprises a top wall 72, a bottom wall 71, and side walls 73, 74.

The enclosure 70 is suspended from a suspension device 60 positioned above the top punch guide 20. A support assembly 360 for the feeder 15 may be connected to this suspension device 60, possibly via the top wall 72 of the enclosure 70. In the embodiment shown, the support assembly 360 comprises one pillar 361 suspended from the enclosure.

The pillar 361 comprises a clamping device 368 for locking the filling device at a predefined position.

Support assemblies 460, 560, 660 of the fourth, fifth and sixth embodiments represent variations of the configuration of at least one pillar supporting the feeder and are not described in further detail.

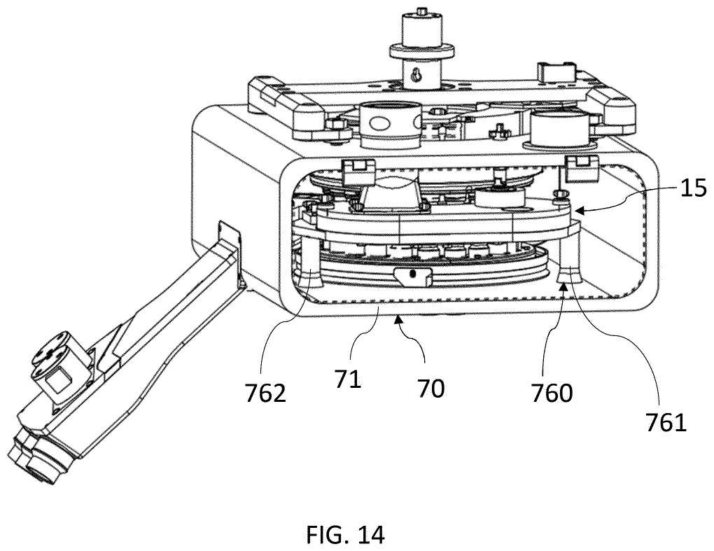

FIG. 14 shows a perspective view of details of a rotary tablet press in a seventh embodiment of the invention.

In this embodiment, a support assembly 760 is provided to support the feeder 15. The support assembly 760 comprises two pillars 761, 762, by means of which the support assembly 760 supports the feeder 15. The feeder 15 is thereby supported in the axial direction from below. The pillars 761, 762 are arranged in between the bottom wall 71 of the enclosure 70 and the feeder 15. In this embodiment, both the pillars 761, 762 are arranged in between and connected to a bottom wall 71 of the enclosure 70 and to the bottom side of the feeder 15. As shown in FIG. 14, the view to the second portion and across the gap is substantially unimpeded, since the pillars 761, 762 are connected to the feeder 15 at a portion covering less than 10% of the surface area of the second portion of the bottom side. Furthermore, the air gap between the surface of the second portion, which surface faces the bottom wall 71 of the enclosure 70, extends over at least 90% of the surface.

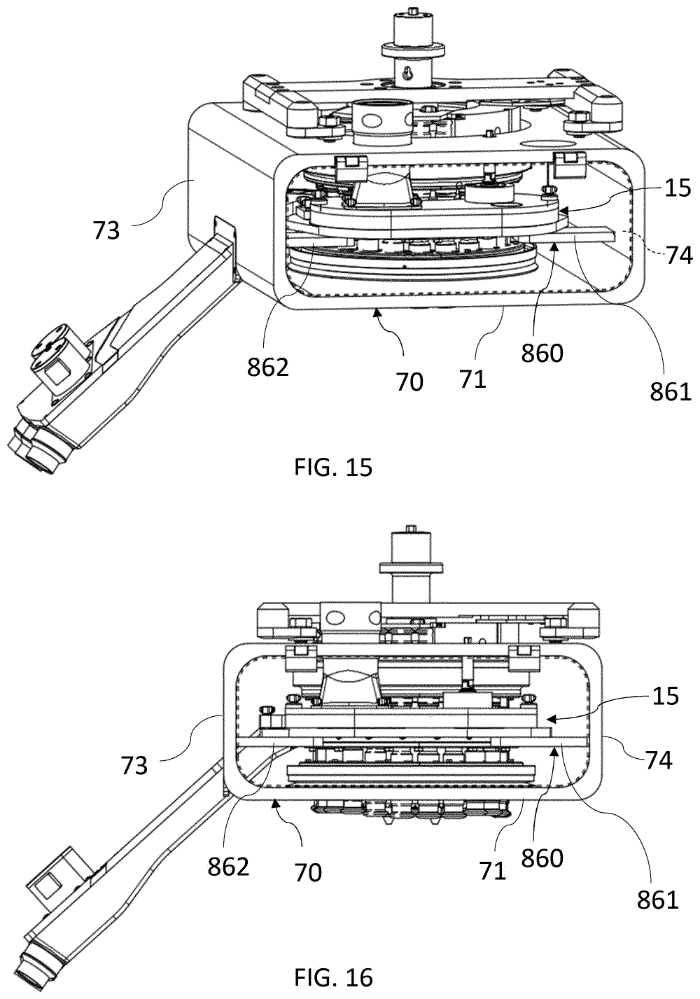

FIG. 15 a perspective view of details of a rotary tablet press in a eighth embodiment of the invention and FIG. 16 is a view corresponding to FIG. 15 of the eighth embodiment of the invention.

In the eighth embodiment, the support assembly 860 is provided to support the feeder 15. The support assembly 860 comprises pillars 861, 862. The pillars 861, 862 are arranged to support the feeder 15 in the radial direction. The pillars 861, 862 are connected to and extend between a respective side surface 74, 73 of the enclosure 70 and the feeder 70. Similar to the seventh embodiment, the view to the gap is substantially unimpeded and the pillars 861, 862 are only connected to a relatively small portion (below 10%) of the surface area of the second portion of the feeder 15, whereby an air gap between the surface of the second portion facing the bottom wall 71 and the bottom wall 71 extends over a relatively large portion (above 90%) of the surface of the second portion.

In other embodiments, support assemblies may be provided, which provide support in both the axial and the radial direction. For instance, support assemblies comprising any combination of pillars 361, 761, 762, 861, 862 may be provided, such as all these five pillars 361, 761, 762, 861, 862, pillars 762 and 861 or pillars 761 and 862 with or without pillar 361. It will moreover be appreciated that the air gap may extend over more than 90% of the surface of the second portion or less than 90% of the surface of the second portion. Similarly, pillars may in these and other embodiments be connected to an area of more than 10% of the surface area of the second portion of the feeder or less than 10% of the surface area of the second portion of the feeder.

### LIST OF REFERENCE NUMERALS

1 rotary tablet press
2 housing
2a wall element
2b wall element
3 frame
4 outer lining
5 drive section
6 compression section
7 bottom frame
8 accessory section
9 top frame
10 turret
11 tablet chute
12 filling device
13 powder inlet tube
14 powder distribution device/fill shoe feeder
   15.1 first portion of bottom side of feeder
   15.2 second portion of bottom side of feeder
   15.3 openable part
   15.4 hinge connection
20 top punch guide
25 top punch
30 bottom punch guide
35 bottom punch
40 die disc
42 die disc top side
60 support assembly/suspension device
160 support assembly of first embodiment
161 pillar
162 pillar
163 pillar
164 pillar
165 pillar
167 adjustment device
169 plate
260 support assembly of second embodiment
261 pillar
262 pillar
263 pillar
264 pillar
265 pillar
269 plate
360 support assembly of third embodiment
361 pillar
368 clamping device
460 support assembly of fourth embodiment
560 support assembly of fifth embodiment
660 support assembly of sixth embodiment
760 support assembly of seventh embodiment
761 pillar
762 pillar
860 support assembly of eighth embodiment
861 pillar
862 pillar
70 enclosure
71 bottom wall
72 top wall
73 side wall
74 side wall

What is claimed is:

1. A rotary tablet press comprising
a turret comprising a die disc, a top punch guide , a bottom punch guide, and a plurality of punches, and
at least one filling device associated with the turret, the filling device comprising a feeder positioned between the die disc and the top punch guide and comprising a bottom side facing a top side of the die disc,
wherein the turret defines an axial direction (z), a radial direction (r), and a tangential direction (θ), and
wherein the rotary tablet press comprises a support assembly for providing support to the feeder , and
wherein the bottom side of the feeder comprises a first portion and a second portion, wherein the first portion overlaps the top side of the die disc, that the support assembly comprises at least one pillar configured to set a predefined gap in the axial direction (z) between the bottom side of the feeder and the top side of the die disc in the overlapping first portion, and that the at least one pillar is configured such that the view to the second portion and across the gap is substantially unimpeded.

2. The rotary tablet press according to claim 1, wherein the at least one pillar is configured to be arranged so that an air gap in the axial direction (z) between a surface of the second portion and another part of the rotary tablet press, such as a bottom surface of the rotary tablet press or a bottom wall of an enclosure, extends over at least 50% of the surface of the second portion.

3. The rotary tablet press according to claim 1, wherein the feeder is supported by the at least one pillar in one or more of the axial direction (z) or in the radial direction (r).

4. The rotary tablet press according to claim 1, wherein at least one of said the at least one pillar extends between a bottom surface of the rotary tablet press and the feeder, such as the second portion of the bottom surface of the feeder.

5. The rotary tablet press according to claim 1, wherein the at least one of said the at least one pillar extends between a top surface of the rotary tablet press or an enclosure thereof and a top side of the feeder.

6. The rotary tablet press according to claim 5, wherein the feeder is suspended by the at least one pillar to allow adjustment of the bottom side of the feeder relative to the top side of the die disc.

7. The rotary tablet press according to claim 1, wherein at least one of said the at least one pillar extends between a side surface of the rotary tablet press or an enclosure thereof and the feeder.

8. The rotary tablet press according to claim 1, wherein the rotary tablet press comprises an enclosure surrounding the turret in its operational position in a compression section of the rotary tablet press.

9. The rotary tablet press according to claim 8, wherein the enclosure is suspended from a suspension device positioned above the top punch guide.

10. The rotary tablet press according to claim 8, wherein said the at least one pillar is suspended from the enclosure.

11. The rotary tablet press according to claim 8, wherein the bottom surface and the side surface are provided on the enclosure.

12. The rotary tablet press according to claim 1, wherein the bottom side of the feeder is substantially plane.

13. The rotary tablet press according to claim 1, wherein the second portion of the bottom side is free-hanging such that the view to the second portion and across the gap is unimpeded.

14. The rotary tablet press according to claim 1, wherein said the at least one pillar extends from a bottom surface of the rotary tablet press or an enclosure thereof to the feeder , and wherein the geometrical extension of said the at least one pillar, as projected on the second part of the bottom surface, and as projected on a vertical plane parallel to the axial direction (z), is below 10%, of the second portion of the bottom surface and on the projected area, respectively.

15. The rotary tablet press according to claim 1, wherein at least one part of the second portion is openable, preferably by means of a hinge connection.

16. The rotary tablet press according to claim 1, wherein said the at least one pillar comprises a clamping device for locking the feeder at a predefined position.

17. The rotary tablet press according to claim 1, wherein the at least one pillar of the support assembly comprises one or more adjustment devices configured to allow an adjustment of the position of the filling device in the axial direction (z), the radial direction (r), and the tangential direction (θ).

18. The rotary tablet press according to claim 4, wherein the at least one pillar comprises one pillar, two pillars, or three pillars.

19. The rotary tablet press according to claim 6, wherein the feeder is exclusively suspended by the at least one pillar.

20. The rotary tablet press according to claim 14, wherein the geometrical extension of the at least one pillar, as projected on the second part of the bottom surface, and as projected on a vertical plane parallel to the axial direction (z), is below 5% of the second portion of the bottom surface and on the projected area.
